(19) United States
(12) Patent Application Publication
(10) Pub. No.: US 2014/0050947 A1
(43) Pub. Date: Feb. 20, 2014

(54) Hybrid Electrochemical Energy Storage Devices

(71) Applicant: Recapping, Inc., Menlo Park, CA (US)

(72) Inventor: Niall J. Donnelly, St. Paul, MN (US)

(21) Appl. No.: 13/959,220

(22) Filed: Aug. 5, 2013

Related U.S. Application Data
(60) Provisional application No. 61/680,689, filed on Aug. 7, 2012.

(51) Int. Cl. H01G 11/04; H01M 16/00; H01M 8/18; H01M 8/20

(52) U.S. Cl. CPC H01G 11/04; H01M 8/20; H01M 16/003; H01M 8/188
USPC 429/7; 429/498; 361/502

(57) ABSTRACT

Electrochemical energy devices such as batteries, flow cells and EDLCs that employ redox active electrolytes are disclosed. Redox active electrolytes for use in these devices also are disclosed that includes one or more redox active salts and optional additive salts. Electrochemical energy devices such as batteries, flow cells and EDLCs that employ the disclosed electrolytes may exchange more than one electron per redox species and may achieve much higher energy densities.

### REFERENCE TO RELATED APPLICATIONS

This application claims priority to U.S. Provisional Patent Application 61/680,689 filed Aug. 7, 2012, the contents of which are incorporated by reference herein by their entirety.

This invention was made with government support under Contract No. DE-AR0000070, awarded by Advanced Research Projects Agency-E. The Government may have certain rights in the invention.

### BACKGROUND

Electrochemical energy storage devices such as batteries, capacitors, hybrid or asymmetric batteries and so forth that store and supply electrical energy or a current are characterized by ionic transfer. In a battery, ions are stored in the bulk of the electrode particles. In an electrochemical double layer capacitor (EDLC), ions accumulate on the surface of the electrode particle but remain in the electrolyte. Pseudo-capacitance is an example of ion storage in an electrode particle in an EDLC. However, in contrast to batteries, the ions remain near the surface of the electrode particle and do not diffuse into the bulk of the particle.

In another variation of ionic transfer, ions are stored in the bulk of the electrolyte. In this variation, ionic species undergo reversible faradaic charge transfer reactions at surface sites on the electrode material, but instead of entering the electrode particle, the oxidized/reduced ionic species diffuse back into the electrolyte. This form of ionic transfer is the basis of both anodes and cathodes in a flow battery.

Batteries have high capacity since ionic charge is stored within the entire volume of the electrode particles. Batteries, however, suffer from long-term capacity fading due to continuous strain changes that occur on cycling. EDLC's have lower energy density but have very good long-term stability due to absence of strain changes.

Flow cells use redox reactions in the electrolyte species to store charge and only require contact between the electrolyte species and a conductive electrode surface to exchange electrons. Flow cells have better long-term stability than batteries. However, conventional flow cell chemistries only operate with one electron transfer per redox species in the electrolyte. For instance, a typical redox reaction in a vanadium flow cell is V²⁺<->V³⁺+e⁻ where the vanadium ion exchanges only one electron. The energy density of a flow cell is proportional to the number of electrons exchanged per unit volume of electrolyte.

Electrochemical energy devices such as batteries, EDLCs and flow cells have found a wide variety of applications. A continuing need, however, exists for improved electrochemical energy devices, including improved electrolytes employed in those devices.

### BRIEF DESCRIPTION OF THE DRAWINGS

FIG. 1 is a schematic of an electron transfer reaction between a redox-active-anion (RAA) and an electrode particle at an electrode;

FIG. 2 shows a schematic of a flow cell battery;

FIG. 3 shows a schematic of a hybrid electrochemical energy device where the negative electrode is an electrochemical double layer capacitive (EDLC) electrode;

FIG. 4 shows a schematic of a hybrid electrochemical energy storage device where the negative electrode is a battery type (faradaic) electrode.

### SUMMARY

Electrochemical energy devices such as batteries, flow cells and EDLCs that employ redox active electrolytes are disclosed. Redox active electrolytes for use in these devices also are disclosed. Electrochemical energy devices such as batteries, flow cells and EDLCs that employ the disclosed electrolytes may exchange more than one electron per redox species and may achieve much higher energy densities.

The electrochemical energy storage devices typically employ a cathode and an anode separated by an ion exchange membrane, optionally with a porous separator membrane. The devices employ a redox active electrolyte solution that includes one or more redox active salts and optional additive salts. The redox active salts provide one or more redox active anions and may undergo reversible electron exchange reactions. Typically, at least one of redox action ions is a polyatomic ion. Flow cells may employ one or more, such as two redox active electrolytes.

Hybrid electrochemical energy storage devices where one electrode uses a redox active electrolyte and the other electrode is either a battery type (faradaic) electrode or an EDLC type double layer electrode also may employ redox active electrolytes.

Electrochemical energy storage device are disclosed that includes a cathode, anode, and a cation permeable separator membrane between the cathode and the anode is disclosed. The device includes a redox active electrolyte wherein the electrolyte includes one or more redox active salts such as Mo₆Cl₁₂, HMo₆Cl₁₃, LiMo₆Cl₁₃, Li₂MoO₄, Li₂Mo₂O₇, Na₂MoO₄, Na₂Mo₂O₇, NaMo₆Cl₁₃, NaMo₆Cl₁₃, Li₂WO₄ and Li₂W₂O₇ and combinations thereof for generating redox active anions in the redox active electrolyte. The redox active anions may be any of poly-anions, poly-oxo-metalates, and metallic cluster ions. The poly-anions are any of the formula [Mₙr]^{y-} where M is any of V, Nb, Ta, Cr, Mo and W cations, n is 2 to 6, r is any O, F, Cl where y in [Mₙr]^{y-} is charge of anion or the formula (MₙXᵥ)^{z-} where M is Mo, W, Nb, Tc, Ru, Rh, Ta, Re, Os, Ir, X is a ligand, v is 7 to 24, and n is 2 to 7. The poly-oxo-metalates may be any of the formula MX₆ octahedra where M is any of Si, Ge, Ga, B, P V, Nb, Ta, Cr, Mo or W, and X is any of oxygen, sulphur, fluorine or of the formula [ZO₄(MO₃)ₙ]^{y}— where Z is any of Si, P, S, Ge, As, Se, M is any of Mo, W, Nb, V, Tc, n is 6 to 22 and y is the charge of the anion or of the formula AM₆O₂₄ⁿ⁻ or AM₁₂O₄₀ⁿ⁻ or A₂M₁₈O₆₂ⁿ⁻ where A any of B, Al, Ga, Si, Ge, Sn, P, As, Sb, Se, Te and M is any of V, Nb, Ta, Mo or W and n is charge on the anion.

The metallic cluster ions are of the formula M₆X₈″, where M is any of Nb, Ru, Rh, Pd, Ag, Cd La, Hf, Ta, Re, Os, Ir, Pt, Au Ti, Zr, Hf, V, Nb, Ta, Cr, Mo W, Mn, Tc, Re, and X is any of S, Se, Te, F, Cl, Br, I, At and n is charge on the ion or of the formula Mo₆X₁₂ where X is any of F, Cl, Br, I, At, alkali Mo halides comprising NMo₆X₁₂ where X is any of F, Cl, Br, I, At and N is any of Na, K, Rb, Cs.

In the electrochemical energy storage devices, the anode may be any of lithium metal, sodium, graphitic carbon, nickel metal hydride, metallic zinc, magnesium and lead. The cation membrane may be any of tetrafluoroethylene-perfluoro-3,6-dioxa-4-methyl-7-octenesulfonic acid copolymer and polyethylene oxide. Where the electrochemical energy storage device is a capacitor, the negative electrode is an EDLC type electrode and the cathode includes a redox active electrolyte. The capacitor may be an electrochemical double layer capacitor that an electrode that has a redox active electrolyte.

The redox active salts have one or more redox active anions wherein the redox active ions are hetero-poly-anions that include a transition metal core and at least one ligand. The metal core may include any of W, Y, Zr, V, Nb, Tc, Ru, Rh, Ta, Re, Os ions and the ligands may be any of O²⁻, S²⁻, F⁻, Cl⁻, Br⁻, I⁻, CH₃, C₂H₅, C₃H₇, C₄H₉, amines, carbonates, phenols, ethers and combinations thereof. The hetero-poly-anions may include a transition metal core and 6 to 8 ligands.

The cation permeable membrane is permeable a cation such as NH₄⁺, tetra-methyl-ammonium, NMe₄⁺, tetra-ethyl-ammonium, NEt₄⁺, tetra-butyl-ammonium NBu₄⁺, and combinations thereof.

The hetero-poly-anions may include a transition metal core having six transition metal ions selected from Group 4 to Group 7 wherein the transition metal ions are in an octahedral formation surrounded by 8 or more ligands selected from the group of F, Cl, Br, I, S, O, Se and Te.

The electrochemical energy storage device may be a flow cell. The flow cell includes an anode section, a cathode section and an ion selective membrane for separating the anode section from the cathode section. The anode section includes conductive material for electron exchange with anolyte solution contacting the conductive material. The cathode section includes conductive material for electron exchange with catholyte solution contacting the conductive material. At least one of the anolyte and catholyte includes redox active electrolyte. The anolyte and catholyte may the same or different.

The electrochemical energy storage device also may be a hybrid battery that includes a negative electrode, a cation permeable separator membrane and a redox active electrolyte cathode wherein the negative electrode is suitable for undergoing redox reactions with a cation present in the redox active electrolyte. The negative electrode may be any of lithium metal, sodium, graphitic carbon, lithium titanate, LiVO₂, nickel metal hydrides, metallic zinc, magnesium and lead. The negative electrode also may be lithium metal and the cathode may be carbon treated with redox active LiMo₆Cl₁₃ electrolyte solution.

### DETAILED DESCRIPTION

### Materials

### Redox Active Salts for Use in Redox Active Electrolytes

Redox active electrolytes that may be employed in electrochemical energy storage devices may include one or more redox active salts dissolved in the solvent of the electrolyte. Salts that may be employed have one or more cations and one or more redox active anions (“RAA”). The RAA typically are capable of exchanging more than one electron at an electrode.

Examples of redox active salts that may be employed include but are not limited to alkali transition metal salts such as but not limited to alkali molybdate salts and alkali tungstate salts. Other redox active salts that may be employed include Keggin type anion salts, Dawson type anion salts and metallic cluster type salts. Mixtures of these salts also may be employed.

Examples of alkali molybdate salts include but are not limited to Li₂MoO₄, Li₂Mo₂O₇, Na₂MoO₄, Na₂Mo₂O₇ and mixtures thereof available from Sigma-Aldrich. Examples of alkali tungstate salts include but not limited to Li₂WO₄, Li₂W₂O₇ and mixtures thereof available from Sigma-Aldrich. Examples of Keggin type anion salts include but are not limited molybdate salts such as but not limited to H₃PMo₁₂O₄₀, alkali silic tungstate salts such as but not limited to Li₃SiW₁₂O₄₀, and molybdosilicic salts such as but not limited to (Zn₂H)SiMo₁₂O₄₀ and mixtures thereof. These salts may be synthesized as described below. Examples of Dawson type anion salts include but are not limited to chalcomolybdate salts including but not limited to Li₄S₂Mo₁₈O₆₂, Na₄S₂Mo₁₈O₆₂, and tungstate salts including but not limited to Li₆P₂W₁₈O₆₂, Na₄P₂W₁₈O₆₂ and mixtures thereof. Examples of metallic cluster compounds include but are not limited to HMo₆Cl₁₃, LiMo₆Cl₁₃, NaMo₆Cl₁₃ and mixtures thereof, and combinations of any of the above available from American Elements Co.

Redox active salts such as those above for use in redox active electrolytes have good solubility, high conductivity, chemical inertness, and stability over the operating voltage range of the electrodes of the electrochemical energy devices in which the electrolytes are employed. The redox active salts are capable of undergoing reversible electron transfer reactions. High conductivity may be obtained from salts that dissociate into positive and negative ions in solution that diffuse readily through the solvent. Typical high conductivities are about 0.1 S/cm and moderate conductivities are about 0.1 mS/cm.

The solubility of the redox active salts may vary over wide range depending on factors such as solvent and temperature. Typically, the salts have a good solubility of about 10⁻³M to about 5M or more, such as about 0.1 M to about 5M, or about 1M to about 5M.

### Additive Salts for Use in Redox Active Electrolytes

Additive salts may be employed with redox active salts to further increase electrolyte conductivity and ionic strength of redox active electrolytes. The additive salts are selected to be compatible with the redox active salts and with the type of electrolyte solvents in which the redox active salts are employed.

Examples of additive salts for use in organic electrolytes include but are not limited to alkyl ammonium phosphates such as tetra-ethyl-ammonium hexafluorophosphate (TEA-PF₆); lithium fluoro salts such as but not limited to LiPF₆, LiBF₄, LiAsF₆ and mixtures thereof; lithium oxy halo salts such as but not limited to LiClO₄, organosulfo type salts such as Lithium-Bis(Trifluoromethanesulfonyl)Imide (TFSI) and organo-borate type salts such as Lithium bis(oxalate)borate, (LiBOB).

Examples of additive salts for use in aqueous electrolytes include but are not limited to HCl, alkali halides such as but not limited to NaCl, KCl, KBr, KI, NaBr, NaI, LiCl, LiBr, LiI, RbCl, RbBr, RbI and combinations thereof; alkaline earth halides such as but not limited to MgCl₂, MgBr₂, MgI₂, CaCl₂, CaBr₂, CaI₂, alkali hydroxides such as but not limited to NaOH, KOH, RbOH, CsOH and sulfates such as H₂SO₄ and mixtures thereof.

### Solvents for Use in Redox Active Electrolytes

Both organic solvents and aqueous solvents may be employed in redox active electrolytes. Examples of organic solvents include but are not limited to alkylene carbonate esters, aryl carbonate esters, alkyl carbonate esters such as but not limited to alkyl carbonate esters such as dimethylcarbonate, propylene carbonate, and diethylcarbonate, and acetonitrile, and combinations thereof. Examples of aqueous solvents include but are not limited to water, aqueous hydrochloric acid, aqueous sulphuric acid, aqueous alkali halides such as KCl solution, NaCl solution and combinations thereof.

### Redox Active Anions

The Redox Active Anions (RAA) provided by redox active salts employed in the redox active electrolytes are hetero-poly-anions (HPA) that include a core of one or more metal ions coordinated by one or more ligands. The core of an HPA includes one or more transition metal ions where a transition metal ion may have two or more accessible valance states.

HPAs employ transition metal ions that have multiple valance states such as any one or more of transition metals of the 5^{th} and 6^{th} rows of the periodic table such as Mo, W, Y, Zr, V, Nb, Tc, Ru, Rh, Ta, Re, Os ^{and} combinations thereof. Suitable HPAs include the following categories: (1) poly-anions such as [Mₙr]^{y-} where M is any of V, Nb, Ta, Cr, Mo and W cations, n is 2 to 6, r is an anion such as O, F, Cl; and y is the magnitude to the negative charge, from 1 to 4. (2) poly-oxo-metalates and derivatives thereof that employ poly-ion constructs that include MX₆ octahedra where M represents V, Nb, Ta, Cr, Mo or W, and where M is octahedrally coordinated by ligand X such as oxygen, sulphur, fluorine and combinations thereof; and (3) metallic cluster ions where the base unit is an M₆ octahedron where M represents any one or more of V, Nb, Ta, Cr, Mo and W in a low oxidation state of 0 to 1 and where the base unit is coordinated by anions or other ligands where the anions are typically halides such as but not limited to F, Cl, Br, I, O, S, Te, Se or organic ligands such as but not limited to DMF.

Ligands may be non-metals that coordinate around the transition metal cluster core. Examples of non-metal ligands include but are not limited to O²⁻, S²⁻, F⁻, Cl⁻, Br⁻, I⁻ and combinations thereof. The ligands may include organic species such as cyclic alkyls such as but not limited to cyclo butane and cyclo pentane; as well as linear and branched alkyls such as but not limited to —CH₃, —C₂H₅, —C₃H₇, and —C₄H₉. In addition, ligands may be combinations of non-metals and alkyls such as —CH₂F, —CH₂Cl, —CH₂Br and —CHF₂. The ligands also may include alkylamines such as but not limited to ethylamine, methylamine, propylamine and combinations thereof; alkylene carbonates such as ethylene carbonate, propylene carbonate, and combinations thereof; alkyl carbonates such as but not limited to di-methyl carbonate, ethyl-methyl carbonate and mixtures thereof; phenols such as but not limited to phenolic acid, and alkyl ethers such as but not limited to diethylether, and combinations thereof.

HPA's may be employed in several forms. In a first aspect, the HPA's may be poly-anions such as those formed by transition metal elements such as Mo, W, Nb, Tc, Ru, Rh, Ta, Re, Os, Ir, and combinations thereof in aqueous environments. These poly-anion type HPA's have the formula (MₙXᵥ)^{z-} where M is one or more transition metal ions coordinated by y ligands (X), n is 2 to 7, v is 7 to 24 or more, such as 7 to 24, and z represents the charge of the anion. Ligands (X) may include any of those discussed above. Non-limiting examples of poly-anion type HPAs include but are not limited to Mo₇O₂₄⁶⁻, W₆O₁₉², and combinations thereof.

In a second aspect, the HPAs may be poly-oxo-metalate anions where transition metal ions are typically surrounded by 6 ligands to form octahedra that assemble to form complex structures that have 2 or more of the octahedra. These poly-oxo-metalate anion type HPAs have transition metal Ion cores that may include ions of semi metals such as Si, Ge, Ga, B, P and combinations thereof. Transition metal Ion cores may include 4^{th} row transition metal ions such as but not limited to ions of any one or more of Fe, Cr, Co and Mn. Non-limiting examples of poly-oxo-metalate anion type HPAs include but are not limited to Keggin Structure type poly-oxo-metalates of the formula [ZO₄(MO₃)ₙ]^{y-} where Z is any one or more of Si, P, S, Ge, As, Se and combinations thereof, M is any one or more of Mo, W, Nb, V, Tc and combinations thereof, n is 6 to 22 and y is the charge of the anion. Non-limiting examples of Keggin Structure type poly-oxo-metalate anions include but are not limited to SiMo₁₂O₄₀³⁻, PMo₁₂O₄₀³⁻, H₂CoW₁₂O₄₀⁶⁻ and combinations thereof.

In a third aspect, the HPAs may be metallic cluster anions that may undergo multiple reversible electron transfers. Metallic cluster anions are poly-anions formed by octahedra of a transition metal coordinated by eight nearest neighbor ligands to give positively charged cluster cores of the formula M₆X₈ⁿ⁺, where M is a transition metal from Groups 4-7, such as but not limited to Ti, Zr, Hf, V, Nb, Ta, Cr, Mo W, Mn, Tc, Re and combinations thereof, and X is chalco-halide such as but not limited to S, Se, Te, F, Cl, Br, I, At and combinations thereof, and n is the charge on the ion. Metallic cluster anions include transition metal cores such as but not limited to Mo, W, Y, Zr, Nb, Tc, Ru, Rh, Pd, Ag, Cd La, Hf, Ta, Re, Os, Ir, Pt, Au and combinations thereof where the cores are coordinated by a variety of ligands and combinations thereof that impart an overall negative charge to the anion. The ligands may include but are not limited to halides, polar (hydrophilic) aprotic solvents, linear and branched alkyls and combinations thereof. Halides that may be employed include but are not limited to Cl⁻, Br⁻, I⁻ and combinations thereof; polar (hydrophilic) aprotic solvents that may be employed include but are not limited to tertiary amides such as N,N-dimethylformamide (DMF); N-Methyl-2-pyrrolidone (NMP), Acetonitrile (CAN), Dimethyl sulfoxide (DMSO) and mixtures thereof. Linear and branched alkyls that may be employed include but are not limited to —C₂H₅, —C₃H₇, —C₄H₉, —C₅H₁₁ and combinations thereof.

Metallic cluster anions typically exhibit metal-metal bonding in the cluster cores and lower oxidation states compared to hetero-poly-anions. Metallic cluster anions compounds include but are not limited to Mo halides of the formula Mo₆X₁₂ where X is a halide such as F, Cl, Br, I, At and combinations thereof; alkali Mo halides of the formula NMo₆X₁₂ where X is a halide such as F, Cl, Br, I, At and combinations thereof and N is an alkali metal such as Na, K, Rb, Cs and combinations thereof. A variety of organic ligands may replace the outer halide to form organic metallic cluster compounds of the formula Mo₆X₁₂₋ₓRₓ where 0≦x≦4 and R is a polar (hydrophilic) aprotic solvent such as but are not limited to tertiary amides such as N,N-dimethylformamide (DMF); N-Methyl-2-pyrrolidone (NMP), Acetonitrile (CAN), Dimethyl sulfoxide (DMSO) and mixtures thereof. Non-limiting examples of organic metallic cluster compounds include but are not limited to Mo₆Cl₁₂(DMF)₂ where DMF is di-methyl-formamide. Other examples of metallic cluster compounds that may be employed include but are not limited to MoCl₂ where the base unit is a Mo_{b} octahedron surrounded by Cl⁻ ions. Additional examples of metallic cluster compounds that may be employed include but are not limited to Mo halides such as but not limited to Mo₆Cl₁₂, Mo₆I₈⁴⁺, Mo₆Cl₈⁴⁺, Mo₆Br₈⁴⁺, W halides such as but not limited to W₆Br₈⁴⁺, W₆I₈⁴⁺, W₆Cl₈⁴⁺, and alkali Mo type salts such as but not limited to LiMo₆Cl₁₃ and combinations thereof.

### Poly-Oxo-Metalates and Derivatives Thereof for Use as HPAs

Poly-oxo-metalate anions suitable for HPAs include octahedral building blocks of any of V, Nb, Ta, Mo and W surrounded by six ligands that are predominantly oxygen but also may include sulfur, tellurium or selenium. Poly-oxo-metalate anions that may be employed include but are not limited to homo-poly-anion clusters such as M₆O₁₉²⁻, M₇O₂₄⁶⁻, M₈O₂₆⁴⁻, M₁₂O₃₈⁴⁻ and hetero-poly-anions such as AM₆O₂₄ⁿ⁻ (Anderson ion) AM₁₂O₄₀ⁿ⁻ (Keggin ion) and A₂M₁₈O₆₂ⁿ⁻ (Dawson ion) where A is a hetero-ion such as but not limited to B, Al, Ga, Si, Ge, Sn, P, As, Sb, Se, Te and combinations thereof, and M is V, Nb, Ta, Mo or W and combinations thereof.

Poly-oxo-metalate anions may be modified by substitution of any one or more of V, Nb, Ta, Mo and W with first row transition metals such as Sc, Ti, Cr, Mn, Fe, Co, Ni, Cu, Zn and combinations thereof; second row transition metals such as Y, Zr, Tc Ru, Pd, Ag, Cd, In, Sn, Sb, Te and combinations thereof, and third row transition metals such as La, Hf, Re, Os, Ir, Pt, Au, Hg, TI, Pb, Bi and combinations thereof. Poly-oxo-metalate anions also may be modified by incorporation of additional hetero-ions into the framework of the poly-ion. Additional hetero-ions that may be incorporated into the ligand framework of the poly-ion include but are not limited to B, Al, Ga, Si, Ge, Sn, P, As, Sb, Se, Te and combinations thereof. Typically, incorporations may be accomplished by addition of an oxide of the substituent ion to the initial precursors employed in the synthesis of these materials.

### Preparation of Molybdate Poly-Anion, Redox Active Organic Electrolytes

Redox active organic electrolytes of redox active molybdate poly-anions that have transition metal anions such as MoO₄²⁻ or Mo₂O₇²⁻ may be prepared by dissolving an oxide such as a transition metal oxide such as MoO₃ in an organic, basic solvent. The resulting solution is concentrated to saturation and cooled to precipitate a molybdate poly-anion, redox active salt. To illustrate, 100 gms of molybdic acid is dissolved in commercially available tetra ethyl ammonium hydroxide (TEAH) at about 45° C. to about 55° C. The resulting solution is concentrated to saturation and then cooled to enable precipitation of tetra-ethyl ammonium di-molybdate salt. The salt may be dried in a vacuum for 24 hrs.

A redox active organic electrolyte of the tetra-ethyl ammonium di-molybdate salt may be prepared by dissolving the salt in an organic salt such as acetonitrile at about 20° C. to about 60° C. to a concentration of about 0.1M to about 1.0M.

### Preparation of Hetero Poly Oxometalates

Oxometalate salts of hetero-polyacids such as molybdosilicic acid, phosphotungstic acid, and tungstosilicic acids may be prepared either directly by ion exchange with the acid or from precursors. Hetero-polyacids such as molybdosilicic acid, phosphotungstic acid, and tungstosilicic acids are commercially available from Sigma-Aldrich and from Strem Chemicals. Preparation from precursors entails reaction of the cation precursor with a transition metal anion precursor. Anion precursors include but are not limited to molybdosilicic acid, phosphotungstic acid, and tungstosilicic acids. Cation precursors include but are not limited to transition metal carbonates such as but not limited to nickel carbonate, zinc carbonate, and combinations thereof. Other salts that may be substituted for the transition metal carbonate include but are not limited to NH₃OH, NEt₃OH, NBu₃OH, LiOH, or KOH and combinations thereof.

### Example 1

### Preparation of Ni Molybdophosphate Oxometalate from Precursors

224 grams (0.1 mole) of phosphomolybdic acid, H₃[PMo₁₂O₄₀].23H₂O from Sigma-Aldrich is dissolved in 400 ml of water and 19.52 g of nickel carbonate is added. The mixture is heated to 65° C. and is stirred for 0.5 hr. The resulting green solution is cooled and filtered and allowed to evaporate to enable crystallization as hydrated Nickel PhosphoMolybdate salt, Ni₃[PMo₁₂O₄₀]₂.34H₂O.

### Example 2

### Preparation of Zn Molybdophosphate Oxometalate from Precursors

The procedure employed to produce nickel molybdophosphate is employed except that the nickel carbonate is replaced by 20.62 gms of zinc carbonate.

### Example 3

### Preparation of Na Molybdosilicate Oxometalate from Precursors

28.42 g (0.10 mol), of sodium silicate hydrate Na₂SiO₃.9H₂O, 24.2 g (0.10 mol) of Na₂MoO₄.2H₂O, and 158.4 g (1.1 mol) of MoO₃ are added to 400 ml of deionized water at room temperature. The solids are dissolved under reflux for 2 hrs. The resulting yellow solution is filtered and allowed to evaporate to enable formation of hydrated crystals of sodium Molybdosilicate.

### Example 4

### Preparation of Li Molybdophosphate Oxometalate by Ion Exchange

224 gms (0.1 mol) of PhosphoMolybdic acid is dissolved in 400 ml of water at room temperature and the solution is passed through a Li-ion exchange column to replace protons in the solution with Li ions. The treated solution is filtered and allowed to evaporate to enable formation of lithium Molybdophosphate crystals. The crystals are vacuum dried at 90° C. for 3 days prior to use in an organic electrolyte.

### Preparation of a Hetero-Poly-Anion Redox Active Organic Electrolyte

Redox active hetero-poly-anion salts may be dissolved in organic solvent electrolytes to form redox active organic electrolytes. The pH of the electrolyte may be adjusted using an acid or base such as HCl (more acidic), KOH (more basic). The hetero-poly-anion salts may be dissolved in organic solvents such as acetonitrile, di-methylformamide, di-methyl carbonate, ethyl-methyl carbonate, ethylene carbonate, propylene carbonate, tetrahydrofuran, di-methyl sulfone, ethyl-methyl sulfone, di-methyl sulfoxide, or combinations thereof to form redox active organic electrolytes that may have higher voltage stability compared to corresponding aqueous electrolytes. The hetero-poly-anion salts also may be dissolved in mixtures of organic electrolytes and aqueous electrolytes.

### Preparation of Hetero-Poly-Anion Redox Active Aqueous Electrolyte

Redox active hetero-poly-anion aqueous electrolytes may be prepared by dissolving one or more redox active hetero-poly-anion salts in water and adjusting pH using an acid or base such as HCl (more acidic), KOH (more basic). Other bases that may be used to adjust pH include but are not limited to ammonium hydroxide, potassium hydroxide, lithium hydroxide, sodium hydroxide, tetramethylammonium hydroxide (TMAH), tetraethyl ammonium hydroxide (TEAH) and mixtures thereof.

### Example 5

### Preparation of Aqueous Electrolyte

200 gms of PhosphoMolybdic Acid is dissolved in 100 ml of distilled water at room temperature.

### Preparation of hetero-poly-anion redox active organic electrolyte

Generally, a redox active organic electrolyte solution having a concentration of about 0.01M to about 1M may be formed by dissolving a redox active, hetero-poly-anion salt in an organic solvent.

### Example 6

### Preparation of Redox Active Organic Electrolyte

10 gms of Lithium PhosphoMolybate is dissolved in 100 ml of Di-methyl-Sulfoxide at room temperature to enable formation of a 0.06M organic redox active electrolyte.

### Preparation of Cluster Ion Compounds

Cluster ion compounds may be prepared by reduction of a transition metal pentahalide, MX₅, by the corresponding transition metal, M, at high temperature. To illustrate, Mo₆Cl₁₂ may be prepared by forming a stoichiometric mixture of MoCl₅ and Mo. The mixture is sealed in a Vycor glass tube under vacuum and heated to about 800° C. to about 850° C. for about 1 day to about 5 days to enable formation of Mo₆Cl₁₂.

### Preparation of Alkali Molybdenum Chloride Cluster Compounds

Alkali Molybdenum Chloride cluster compounds for use as HPAs may be prepared by reaction of an alkali halide, a transition metal halide, and a transition metal at high temperature under vacuum.

### Example 7

### Preparation of LiMo₆Cl₁₃ Chloride Cluster Compound

Stoichiometric quantities of LiCl, MoCl₅ and Mo (all commercially available) are mixed and sealed in a Vycor tube under vacuum. The mixture is heated to 800° C. for 20 days and cooled at 1° C./min to room temperature to form LiMo₆Cl₁₃.

### Preparation of redox active organic electrolyte of Lithium Molybdenum Chloride

Organic electrolytes of alkali transition metal halide metallic cluster compounds such as but not limited to alkali molybdenum chloride cluster compounds such as but not limited to LiMo₆Cl₁₃ may be prepared by dissolving about 10 gms to about 100 gms of LiMo₆Cl₁₃ in about 100 ml to about 1000 ml acetonitrile at room temperature to form an organic electrolyte of lithium molybdenum chloride solution. As an alternative to acetonitrile, an organic solvent mixture such as Di-methylcarbonate-Ethylene carbonate (1:1 wt) may be substituted for acetonitrile.

### Preparation of Organic Electrolyte of Li Molybdenum Chloride and Supporting Electrolyte

Organic electrolyte of lithium molybdenum chloride and supporting electrolyte may be prepared by dissolving about 10 gms to about 20 gms of a Li salt such as LiPF₆, LiBF₄ or mixtures thereof in the lithium molybdenum chloride organic solution above to a concentration of about 0.1 M to about 2M, preferably about 1M to form a supporting electrolyte. Then, about 1 gm to about 10 gms of LiMo₆Cl₁₂ is added to about 100 ml of the supporting electrolyte to form an organic electrolyte of Lithium Molybdenum Chloride.

### RAA's, Salts and Preparation of Electrolytes Containing Salts.

### Small Poly Anions

Small poly-anions that have a cation number of 6 or less that may be employed as RAA include but are not limited to molybdate anions such as MoO₄²⁻ or Mo₂O₇²⁻, tungstate anions such as WO₄²⁻ and W₂O₇²⁻, vanadate anions such as V₂O₇⁴⁻, V₄O₁₂⁴⁻ and niobate ions such as Nb₆O₁₉⁸⁻.

In aqueous alkaline solutions of pH>7 such as may be present in an aqueous molybdate-ammonium hydroxide electrolytes, dominant anions typically are MoO₄²⁻ and NH⁴⁺. Commercial salts that may be used as sources of MoO₄²⁻ anions such as in these alkaline solutions include but are not limited to Li₂MoO₄, K₂MoO₄, (NH₄)₂Mo₂O₇, ZnMoO₄ and combinations thereof. Sources of tungstate ions include but are not limited to Li₂WO₄, (NH₄)₁₀H₂(W₂O₇)₆ salts. These salts are available from sources such as Sigma-Aldrich, Alfa Aesar.

### Preparation of Molybdate Small Poly-Anion, Aqueous Electrolytes

Molybdate Small Poly-anion, Aqueous Electrolytes that have small anions such as MoO₄²⁻ or Mo₂O₇²⁻ may be prepared by dissolving an oxide such as MoO₃ or molybdic acid in a basic solution such as aqueous ammonium hydroxide, TMAH, TEAH or combinations thereof to form a solution. The solution then is concentrated to saturation such as by addition of further amounts of the molybdate salt. The saturated solution is cooled to crystallize the salt.

### Preparation of Ammonium Di-Molybdate Salt

MoO₃ may be dissolved in aqueous ammonium hydroxide solution at a pH of about 7 to about 14 at about 30° C. to about 80° C. to a concentration of about 0.1M to about 1.0M. The solution then is concentrated to saturation and cooled. Residual MoO₃ is redissolved by addition of a small amount of ammonium hydroxide and the solution is then cooled to about 0° C. to enable crystallization of ammonium di-molybdate.

### Example 8

### Preparation of Aqueous Electrolyte of Ammonium Di-Molybdate

Ammonium Di-Molybdate is dissolved in distilled water at about 20° C. to a concentration of about 0.1 M to about 1.0M.

### Preparation of an Aqueous Electrolyte of Molybdenum Chloride Cluster Anions

Aqueous electrolytes of molybdenum chloride cluster anions such as Mo₆Cl₈⁴⁻ anions may be prepared by dissolving about 1.67 gms to about 16.7 gms of Mo₆Cl₁₂ in about 100 ml to about 500 ml of about 0.1M to about 3M aqueous HCl at room temperature to enable formation of an acidic electrolyte that includes Mo₆Cl₈⁴⁻ anions.

### Counter Cations Present in Salts in Redox Active Electrolytes

Counter cations that may be present in any of the redox active salts and additive salts utilized in the redox active electrolytes generally are selected for solubility in the electrolyte solvent, ability to function as a supporting electrolyte and to interact with another electrode of the device.

Counter cations present in the salts are sufficiently soluble in aqueous solvents and organic solvents to form a supporting electrolyte such as by creation of acids of transition metal ion cluster compounds whereby the transition ion metal cluster core and ligands effectively become an anion, and the counter cation is (H⁺).

Solubility of counter cations in organic solvents may be achieved using cations such as Li⁺, Na⁺, and combinations thereof. Improved solubility may be achieved by use of organic outer ligands such as DMF. In organic solvents, examples of counter cations include but are not limited to Li⁺, Lithium insertion materials such as graphitic carbon, and elemental Lithium.

Counter cations may be selected based on interaction with an electrode. In aqueous solvents, anodes such as but not limited to nickel metal hydride alloy such as LaNi₅, Pb metal, and combinations thereof may be proton hosts. In aqueous solvents, cathodes include but are not limited to Ni(OH)₂, MnO₂ and combinations thereof. Where the anode is an electrical double-layer capacitor (EDLC) electrode such as an activated carbon compact, counter cations that may be employed include but are not limited to NH₄⁺, alkyl substituted ammonium such as tetra-methyl-ammonium (NMe₄⁺), tetra-ethyl-ammonium (NEt₄⁺), tetra-butyl-ammonium (NBu₄⁺), and combinations thereof where Me is a methyl group, Et is an ethyl group and Bu a butyl group.

### Electrochemical Devices

Flow Cell that Employs Two Redox Active Electrolyte Electrodes

A flow cell that includes a reaction vessel, anode, cathode as cation permeable membrane is shown in FIG. 2. Each of the anode and the cathode contains densely packed conductive particulates for electron exchange with ions in an electrolyte such as a redox active electrolyte. Conductive particles may include but are not limited to any of carbon felt, activated carbon, acetylene black, graphite, nickel foam and mixtures thereof. The anode and cathode are separated by cation permeable membrane such as but not limited to a Li⁺ cation permeable membrane of a PVDF-PEO polymer mixture such as Nafion of the chemical formula tetrafluoroethylene-perfluoro-3,6-dioxa-4-methyl-7-octenesulfonic acid copolymer.

During operation of a flow cell, catholyte electrolyte solution having redox active cations is passed through the cathode compartment whereby the cations are oxidized to a higher oxidation state. Anolyte electrolyte having redox active anions is passed though the anode compartment whereby the anions are reduced to a lower oxidation sate. To maintain charge neutrality, cations from the cathode compartment migrate though the separator membrane into the anode compartment. This may continue until all ions are fully converted to their charge state. The catholyte electrolytes and the anolyte electrolytes may be supplied to the cell at temperatures of about 5° C. to about 55° C. On discharge, the (fully charged) anolyte and catholyte are flowed in reverse through the cathode and anode compartments and the reactions are allowed to proceed in reverse to generate an output voltage across the current collectors.

Catholyte solutions that may be employed include but are not limited to LiMo₆Cl₁₃, Lithium PhosphoMolybate and mixtures thereof. Anolyte solutions that may be employed include but are not limited to LiMo₆Cl₁₃, Lithium PhosphoMolybate and mixtures thereof. The catholyte and anolyte may be the same or different.

The catholyte and anolyte solutions are supplied to the flow cell at rates sufficient to generate a desired power output. Rates of supply of catholyte and anolyte may be the same or different. The solutions may be supplied over a temperature range of about 5° C. about 55° C. The temperatures of anolyte and catholyte supplied may be the same or different.

### Flow Cell 1—Organic Redox Active Electrolyte

A flow cell 1 that includes a reaction vessel 5 where each of the anode compartment 20 and cathode compartment 15 contain packed conductive material 20 such as conductive carbon material such as carbon felt and which are separated by a Li⁺ cation permeable membrane 25 such as PVDF-PEO is shown in FIG. 2. During operation, an organic redox active electrolyte of a metallic cluster compound such as LiMo₆Cl₁₃ in an organic solvent such as acetonitrile is flowed through each of the cathode and anode compartments to an external anolyte tank (not shown) and to an external catholyte tank (not shown). Mo₆Cl₈⁴⁻ ions in the electrolyte are reduced in the anode and oxidized in the cathode to generate a chemical potential difference between the anode and cathode. To maintain charge neutrality, Li⁺ ions cross from one compartment to the other through the cation membrane. During discharge, the reaction directions are reversed and an output voltage is generated across the current collectors 30 on the sides of the flow cell from which current may be drawn.

### Flow Cell 2-Aqueous Redox Active Electrolyte

Flow cell 2 is the same as Flow Cell 1 except that the anolyte electrolyte solution used on the anode side contains 1M CrCl₃ in 2M HCl acid and the catholyte electrolyte solution on the cathode side is 0.1M Mo₆Cl₁₂ in 2M HCl. The membrane is Nafion that is permeable to H⁺ ions.

### Hybrid EDLC (One Redox Active Electrolyte Electrode and One EDLC Electrode)

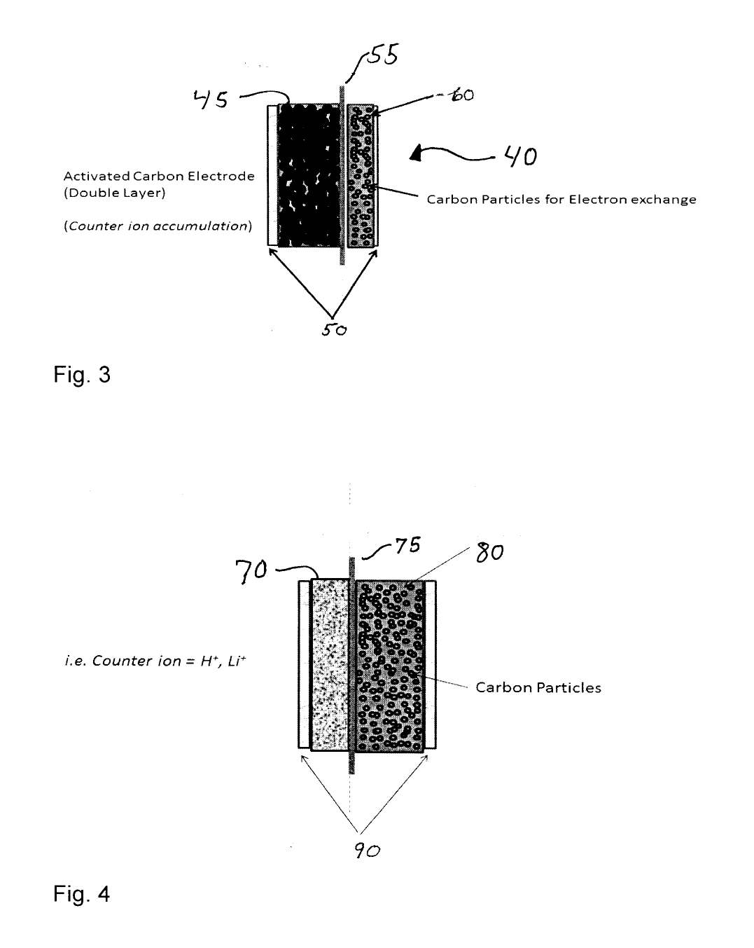

A hybrid EDLC-redox active capacitor 40 that employs an anode in the form of an EDLC type electrode and a redox active cathode is shown in FIG. 3. The hybrid capacitor includes a double layer negative electrode 45 such as YP 50 activated carbon, a separator membrane 55 such as Nafion and a redox active positive electrode 60 such as a YP50 activated carbon electrode containing a redox active liquid electrolyte solution such as aqueous 1.0M Mo₆Cl₁₂ solution housed in a container such as a stainless steel coin cell. A current collector 50 such as stainless steel is attached to the surfaces of the double layer negative electrode and to the redox active positive electrode. During operation, counter ions accumulate on the double layer negative electrode.

Cluster compounds are preferred as the RAA in the redox active positive electrode due to their ability to achieve high oxidation states, such as the +12 Mo_{b} core can achieve +13 and +14 oxidation.

### Hybrid EDLC Anode, Organic Solvent Redox Active Electrolyte Cathode Capacitor

A hybrid EDLC anode may be prepared from a mixture of 85% wt activated carbon, 5% wt acetylene black and 10% wt Teflon. The mixture is compressed at 3000 PSI to enable formation of a thin film carbon anode of 100 um thickness. A disc of the thin film carbon anode is placed in to a coin cell. A 20 micron thick, porous polyethylene separator membrane such as Hipore from Asahi Kasei is placed on the thin film anode and an electrode structure for the redox active electrolyte cathode such as the thin film carbon anode material is placed on top of the separator membrane to enable formation of a tri-layer assembly. The assembly is soaked in 1M Tetra Butyl-Ammonium Molybdenum Chloride (TBA₂-Mo₆Cl₁₄) in acetonitrile:ethylene-carbonate electrolyte solution for one hour to enable infusion of the electrolyte into the assembly.^{THEO}

### Hybrid Battery (Redox Active Electrolyte Electrode and Battery Electrode)

A hybrid battery-redox active electrolyte cathode that employs a negative electrode, cation permeable separator membrane and a redox active electrolyte cathode is shown in FIG. 4. The battery type negative electrode 70 undergoes redox reactions with the cation component of the electrolyte. Battery-type negative electrodes that may be used in the hybrid battery include but are not limited to lithium metal which is a reversible electrode for lithium ions, sodium which is a reversible electrode for Na ions, graphitic carbon, lithium titanate, LiVO₂ all of which are capable of intercalating of lithium ions, nickel metal hydrides, metallic zinc, magnesium and lead where each may be used as a negative electrode in aqueous systems. Battery type graphitic carbon electrodes are available from MTI while all other metals are commercial available (Sigma, Alfa). Nickel metal hydrides are available from suppliers such as Molport. Current collectors such as stainless steel are attached to the surfaces of the negative electrode and to the redox active electrolyte cathode. A cation permeable separator membrane 75 is present between the redox active electrolyte cathode 80 and negative electrode 70. Cation separator membranes that may be used include but are not limited to Nafion where the cations are H⁺. For Li⁺ cations, a polyethylene oxide (PEO) based polymer electrolyte may be used as a cation permeable separator membrane. Alternatively, or in combination with a cation permeable separator membrane, a porous separator membrane such as the polypropylene or polyethylene based separators from Celgard and Asahi Kaseim may be used to permit high diffusivity of cations while limiting diffusivity of RAA and also to provide extra volume for electrolyte solution

A non-limiting example of a hybrid battery is described below. The hybrid battery employs lithium metal as the negative electrode and a high surface area carbon electrode soaked in redox active LiMo₆Cl₁₃ electrolyte solution of 1M LiMo₆Cl₁₃ in a solvent of a mixture of dimethyl-carbonate and ethylene carbonate in the ratio 70:30 (mol) as the redox active electrolyte cathode. A 0.04 mm thick Nafion permeable membrane separates the negative electrode and cathode. Stainless steel current collectors 90 are attached to the anode and cathode.

### Hybrid Battery Anode, Redox Active Organic Solvent Electrolyte

A battery anode may be prepared by compressing lithium metal onto a copper foil to enable formation of a Li layer thickness of up to about 100 μm. A Li permeable membrane is placed on top of the lithium layer. The Li permeable membrane may be any of polyethylene oxide (PEO), PEO polymer containing a dissolved Li salt such as any of LiClO₄, LiPF₆ or mixtures thereof, together with a plasticizer such as propylene carbonate. A typical PEO membrane may be made by dissolving about 5 gms PEO in about 25 ml acetonitrile and casting the solution on a nonstick surface and allowing to dry.

Where PEO is employed in a Li permeable membrane, the membrane may have a thickness of up to about 50 μm. A porous polymer separator such as a polyethylene membrane such as Hipore from Asahi Kasie may be placed on the Li permeable membrane. The separator membrane may have a thickness of about 10 um to about 50 um. A carbon cathode of 85% activated carbon, 5% acetylene black and 10% Teflon binder from Sigma-Aldrich is placed on the porous polymer separator to enable formation of a hybrid battery anode. The carbon cathode disk may have a thickness of about 20 um to about 200 um, such as about 100 um. The carbon cathode typically has a porosity of about 20% to about 50% such as about 25% to about 40%. Both the porous polymer separator and the cathode are soaked in a redox active organic electrolyte that typically includes Li cations. A non-limiting example of a redox active organic electrolyte includes lithium hexafluorophosphate and dehydrated lithium molybdophosphate dissolved to 1M in ethylene carbonate:dimethyl carbonate.

### Hybrid Battery Anode, Aqueous Redox Active Electrolyte Cathode.

An anode may be prepared from a film of Pb metal of about 100 um to about 500 um thickness. A disc of the Pb film is placed on a porous membrane soaked in sulphuric acid and placed in a coin cell casing to enable formation of an anode. The membrane may be a microporous trilayer membrane (PP/PE/PP) such as C480 from Celgard. The membranes typically have a porosity of about 40% to about 60%. A cation permeable membrane such as Nafion™ is placed on top of the anode. A carbon cathode such as from Sigma Aldrich is placed on the cation permeable membrane to form a hybrid battery, redox active electrolyte electrode device. The carbon cathode typically has 85% activated carbon, 5% acetylene black and 10% Teflon binder of about 100 um thickness from and is soaked in 1M HCl electrolyte containing MolyboSilicilic acid H₄-[SiMo₁₂O₄₀] dissolved to 1M prior to use.

### Discharging/Charging of a Hybrid, Redox Active Electrolyte Electrode

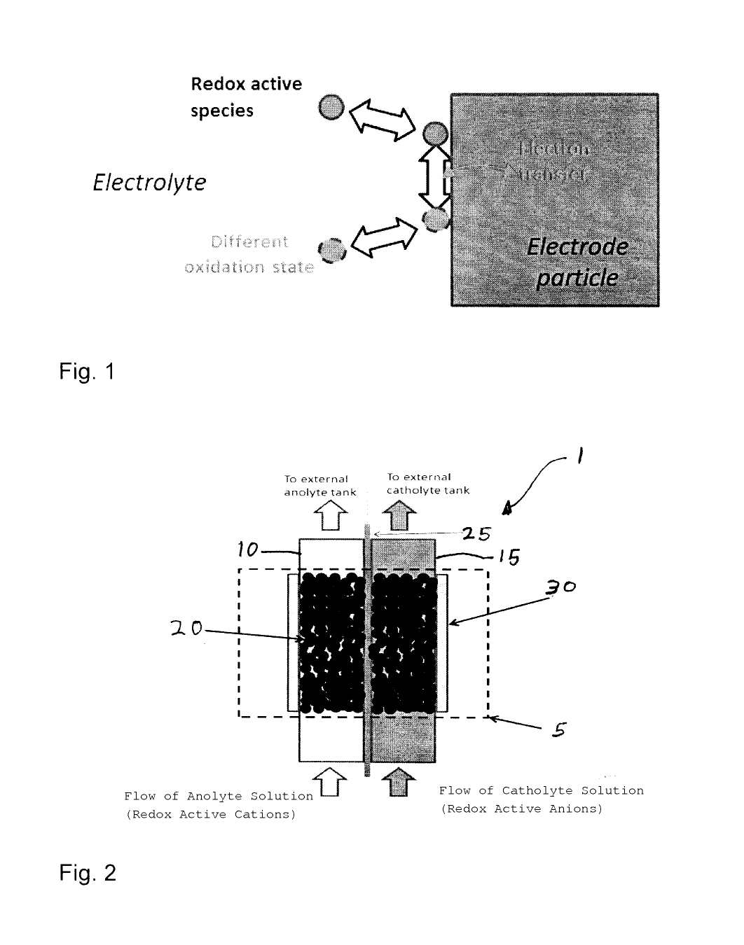

Immediately prior to discharge of a hybrid, redox active electrolyte electrode, RAAs such as in the form of polyoxometalates are in their highest oxidation state. During discharge the RAA are attracted to electrode particles as shown in FIG. 1. Upon reaching the electrode particles, the RAA are reduced by gain of one or more electrons. The reduced RAA diffuse away from the electrode particles to be replaced by fresh RAA. This continues until the electrode reaches a fully discharged state where available RAA are in a lower oxidation state. To maintain charge neutrality in the redox active electrolyte, cations (or anions) are transferred between the cathode electrode and the anode electrode such as through the separator membrane or a specific ion permeable membrane.

Redox active electrodes may be assembled in the discharged state. After assembly, the hybrid redox active electrolyte electrode is charged by electric current whereby electrons are drawn from the positive electrode and supplied to the negative electrode. In this aspect, cluster compounds that have high oxidation states may undergo oxidation reactions in the redox active positive electrode and lose an electron to the carbon particles in the negative electrode.

### Flow Cell Operation

During charging of a flow cell, voltage is applied across the current collectors of the reaction vessel to generate a positive potential on the cathode. Catholyte is supplied through the cathode electrode compartment of the cell whereby RAA in the redox active electrolyte are oxidized to a higher oxidation state. During flow of catholyte, anolyte is supplied through the anode compartment whereby cations reduced to a lower oxidation state. To maintain charge neutrality in the catholyte and anolyte solutions, cations from the cathode compartment migrate through the separator membrane into the anode compartment. This may continue until the ions are converted to their charged state. During discharge of a flow cell, the charged anolyte and catholyte solutions are supplied back into the reaction vessel and the reactions are allowed to proceed in the reverse direction to generate an output voltage. The output voltage is generated across the current collectors to enable energy to be drawn from the cell.

### Hybrid EDLC Operation

In a hybrid EDLC device, charge transfer at the positive redox active EDLC electrode is compensated by an equal amount of charge transfer at the negative EDLC electrode. Cation species from dissolved salt in a redox active electrolyte migrate toward the negative EDLC electrode and accumulate on the particles of the negative electrode as illustrated in FIG. 3. This manner of charge storage in an EDLC electrode may achieve very fast kinetics to enable high-energy capacity and high power.

### Hybrid Battery Operation

Where the negative electrode is a battery electrode, cations are reduced and stored within (or on) the negative electrode of the battery as illustrated in FIG. 4. This manner of charge storage in a hybrid battery that employs the redox active electrolytes may provide high capacity per unit volume.

1. An electrochemical energy storage device comprising a cathode, anode, and a cation permeable separator membrane between the cathode and the anode wherein the device comprises a redox active electrolyte, wherein the electrolyte comprises one or more redox active salts selected from the group consisting of Mo₆Cl₁₂, HMo₆Cl₁₃, LiMo₆Cl₁₃, Li₂MoO₄, Li₂Mo₂O₇, Na₂MoO₄, Na₂Mo₂O₇, NaMo₆Cl₁₃, NaMo₆Cl₁₃, Li₂WO₄, Li₂W₂O₇, and combinations thereof for generating redox active anions in the redox active electrolyte.

2. The device of claim 1 wherein the redox active anions comprise any of poly-anions, poly-oxo-metalates, and metallic cluster ions.

3. The device of claim 2 wherein the poly-anions comprise any of the formula [Mₙr]^{y-} where M is any of V, Nb, Ta, Cr, Mo and W cations, n is 2 to 6, r is any O, F, Cl where y in [Mₙr]^{y-} is charge of the anion or of the formula (MₙXᵥ)^{z-} where M is Mo, W, Nb, Tc, Ru, Rh, Ta, Re, Os, Ir, X is a ligand, v is 7 to 24, and n is 2 to 7.

4. The device of claim 2 wherein the poly-oxo-metalates comprise any of the formula MX₆ octahedra where M is any of Si, Ge, Ga, B, P V, Nb, Ta, Cr, Mo or W, and X is any of oxygen, sulphur, fluorine or of the formula [ZO₄(MO₃)ₙ]^{y}— where X is any of Si, P, S, Ge, As, Se, M is any of Mo, W, Nb, V, Tc, n is 6 to 22 and y is the charge of the anion or of the formula AM₆O₂₄ⁿ⁻ or AM₁₂O₄₀ⁿ⁻ or A₂M₁₈O₆₂ⁿ⁻ where A any of B, Al, Ga, Si, Ge, Sn, P, As, Sb, Se, Te and M is any of V, Nb, Ta, Mo or W and n is charge on the anion.

5. The device of claim 2 wherein the metallic cluster ions comprise the formula M₆X₈ⁿ⁺, where M is any of Nb, Ru, Rh, Pd, Ag, Cd La, Hf, Ta, Re, Os, Ir, Pt, Au Ti, Zr, Hf, V, Nb, Ta, Cr, Mo W, Mn, Tc, Re, and X is any of S, Se, Te, F, Cl, Br, I, At and n is charge on the ion or of the formula Mo₆X₁₂ where X is any of F, Cl, Br, I, At, alkali Mo halides comprising NMo₆X₁₂ where X is any of F, Cl, Br, I, At and N is any of Na, K, Rb, Cs.

6. The device of claim 1 wherein the anode is any of lithium metal, sodium, graphitic carbon, nickel metal hydride, metallic zinc, magnesium and lead.

7. The device of claim 1 wherein the cation membrane is any of tetrafluoroethylene-perfluoro-3,6-dioxa-4-methyl-7-octenesulfonic acid copolymer and polyethylene oxide.

8. The device of claim 1 wherein the device is a capacitor, the negative electrode is an EDLC type electrode and the cathode comprises the redox active electrolyte.

9. The device of claim 1 wherein the device is a flow cell.

10. The device of claim 1 wherein the salts have one or more redox active anions wherein the redox active ions are hetero-poly-anions comprising a transition metal core and at least one ligand, wherein the metal core comprises any of W, Y, Zr, V, Nb, Tc, Ru, Rh, Ta, Re, Os ^{ions} and the ligands are any of O²⁻, S²⁻, F⁻, Cl⁻, Br⁻, I⁻, CH₃, C₂H₅, C₃H₇, C₄H₉, amines, carbonates, phenols, ethers and combinations thereof.

11. The device of claim 10 wherein the hetero-poly-anions comprise the transition metal core and 6 to 8 ligands.

12. The device of claim 1 wherein the cation permeable membrane is permeable a cation selected from the group consisting of NH₄⁺, tetra-methyl-ammonium, NMe₄⁺, tetra-ethyl-ammonium, NEt₄⁺, tetra-butyl-ammonium NBu₄⁺, and combinations thereof.

13. The device of claim 12 wherein the hetero-poly-anions comprise a transition metal core having six transition metal ions selected from Group 4 to Group 7 wherein the transition metal ions are in an octahedral formation surrounded by 8 or more ligands selected from the group consisting of F, Cl, Br, I, S, O, Se and Te.

14. The device of claim 9 wherein the flow cell comprises
an anode section,
a cathode section and an ion selective membrane for separating the anode section from the cathode section,
the anode section having conductive material for electron exchange with anolyte solution contacting the conductive material,
the cathode section having conductive material for electron exchange with catholyte solution contacting the conductive material,
wherein at least one of the anolyte and catholyte comprises redox active an electrolyte.

15. The device of claim 14 wherein the anolyte and catholyte are the same or different.

16. The device of claim 8 wherein the capacitor comprises a electrochemical double layer capacitor comprising an electrode having redox the active electrolyte.

17. The device of claim 1 wherein the device is a hybrid battery having a negative electrode, cation permeable separator membrane and a redox active electrolyte cathode wherein the negative electrode is suitable for undergoing of redox reactions with a cation present in the redox active electrolyte.

18. The device of claim 17 wherein the negative electrode is any of lithium metal, sodium, graphitic carbon, lithium titanate, LiVO₂, nickel metal hydrides, metallic zinc, magnesium and lead.

19. The device of claim 17 wherein the negative electrode comprises lithium metal and the cathode is carbon treated with redox active LiMo₆Cl₁₃ electrolyte solution.
